(19) United States
(12) Patent Application Publication
(10) Pub. No.: US 2021/0271213 A1
(43) Pub. Date: Sep. 2, 2021

(54) SYSTEM AND METHOD FOR THE DETERMINATION OF A REAL PROCESS PARAMETER OF AT LEAST ONE REAL FIELD DEVICE

(71) Applicant: SAMSON AKTIENGESELLSCHAFT, Frankfurt (DE)

(72) Inventors: Gert Nahler, Frankfurt (DE); Klaus Hoerschken, Villmar (DE)

(73) Assignee: SAMSON AKTIENGESELLSCHAFT, Frankfurt (DE)

(21) Appl. No.: 17/259,080

(22) PCT Filed: Jul. 4, 2019
(86) PCT No.: PCT/EP2019/067931

§ 371 Date: Jan. 8, 2021

(30) Foreign Application Priority Data
Jul. 11, 2018 (DE) 10 2018 116 823.3

(51) Int. Cl. G05B 13/04

(52) U.S. Cl. CPC G05B 13/042

(57) ABSTRACT

A system to determine a real process parameter of a real field device in a real flow route of a process plant can include an interface and a virtual twin flow route that may virtually represent the real flow route. A twin process fluid flow is virtually influenced according to a twin influence factor. The virtual twin flow route may: receive, via the interface, a real initial parameter of the real process fluid flow and/or of the real field device, and virtually determine, fluid flow upstream or downstream, a twin process parameter of the twin field device corresponding to the real field device using the at least one twin influence factor, the virtually determined twin process parameter being supplied to the at least one real field device as the to be determined real process parameter for further influencing the real process fluid flow.

### CROSS REFERENCE TO RELATED APPLICATIONS

This patent application is a U.S. National Stage application of International Application No. PCT/EP2019/067931, filed Jul. 4, 2019, which claims priority to German Patent Application No. 10 2018 116 823.3, filed Jul. 11, 2018, each of which is incorporated herein by reference in its entirety.

### BACKGROUND

The present disclosure relates to a system for the determination of a real process parameter of at least one real field device, such as a control valve and/or pump, which is integrated in a real flow route of a process plant, such as a chemical plant, a food processing plant, a power plant or such, and is designed for influencing, such as setting, driving, warming, cooling or such, the real process fluid flow according to a field device-specific real influence factor. The present disclosure relates to a method for the determination of a real process parameter of at least one real field device, such as a control valve and/or a pump, which is integrated in a real flow route of a process plant, such as a chemical plant, a food processing plant, a power plant or such, and is designed for influencing, such as setting, driving, warming, cooling or such, the real process fluid flow according to a field specific real influence factor. Furthermore, the present disclosure relates to a real field device, such as a control valve and/or pump, which is integrated in a real flow route of a process plant, such as a chemical plant, a food processing plant, a power plant or such, and is designed for influencing, such as setting, driving, warming, cooling or such, the real process fluid flow according to a field device-specific real influence factor. Furthermore, the present disclosure relates to a real flow route of a process plant, such as a chemical plant, a food processing plant, a power plant or such, for guiding the real process fluid flow.

From the prior art, as for example taught by DE 10 2013 101 025 A1, pressure and pressure flow calculation methods and systems, respectively, in a distributed process network simulation system are known. A simulation system simulates the operation of a process plant with several field apparatuses, such as valves, valve position controllers, switches or such, including the field apparatuses and the real control network for controlling and regulating, respectively, the field apparatuses. The simulation system is furthermore able to react to changes in the real process network and to check the plant operation under consideration of real changes arising in the real system as well as making a prediction with respect to the plant operation. Numerous real sensors for measuring the real process parameters during the operation of the process plant are employed in order to model the real process as accurately as possible in the simulation system.

For controlling and/or regulating the operation of the process plant and the singular field apparatuses, for example control centers or computer apparatuses according to DE 10 2013 101 025 A1, are employed that are coupled to the field apparatuses via data transmission systems. Such known simulation and calculation systems and methods, respectively have the disadvantage that a plurality of real sensors are needed in order to model the real process plant operation as accurately as possible on the one hand and on the other hand to ensure a safe, precise real process plant operation.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a system for the determination of a real process parameter of at least one real field device integrated in the flow route of a process plant according to exemplary embodiments of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the disclosure is to overcome the disadvantages of the known prior art, in particular to provide a system for the determination of a real process parameter of at least one real field device that is integrated in a real flow route of a process plant, being cost efficient and needing only a reduced number of real sensors as well as ensuring at the same a reliable real process plant operation.

According to one aspect of the disclosure, a system for the determination of a real process parameter of at least one real field device, such as a control valve and/or pump, which is integrated in a real flow route of a process plant, such as a chemical plant, a food processing plant, a power plant or such, and is designed for influencing, such as setting, driving, warming, cooling or such, the real process fluid flow according to a field device-specific real influence factor is provided. In a process plant, normally at least one real flow route for guiding the real process fluid flow is present. In the real flow route, in general at least one real field device is integrated, which influences the real process fluid flow and influences the real process fluid flow accordingly subsequently after one another. The influence of the real process fluid flow by the real field devices takes place by the respective field device-specific real influence factors, such as for example a pressure compaction.

According to the disclosure, the system comprises a virtual twin flow route, in which the real flow route is virtually modeled. In the twin flow route, a twin process fluid flow is influenced virtually according to a twin influence factor of at least one twin field device corresponding to the at least one real field device, the twin influence factor corresponding to at least one real field device. The twin flow route thereby serves to represent a virtual image of the real flow route, in which at least one real field device of the real flow route is also modeled virtually in order to virtually model the real process plant operation, in particular to virtually model the influence of the real process fluid flow through the real field device. For this purpose, a twin influence factor corresponding to the real influence factor is deposited to the twin field device in the twin stream route, so that the twin field device works corresponding to the real field device.

The twin flow route receives a real initial parameter of the real process fluid flow, such as temperature, velocity, pressure, volume flow or such, and/or a real initial parameter of the real field device, such as travel, pump power or such. As initial parameter, a parameter of the real process fluid flow and the real field device is preferably to be understood, which is present downstream of the at least one real field device, that means after the influence of the real process fluid flow by the at least one real field device. This real initial parameter is supplied to the twin flow route at a twin tapping position in the twin flow route corresponding to a real tapping position of the real initial parameter. This particularly serves to update the twin flow route, that means the twin process plant operation, regarding the real process fluid flow state present in the real flow route. The twin flow route determines a twin process parameter of the twin field device corresponding to the at least one real field device virtually by means of the at least one twin influence factors, on the basis of the received real initial parameter, process fluid flow upstream or downstream. The virtually determined twin process parameter, that means the twin process parameter received on the level of a virtual twin flow route, is supplied to the at least one real field device as a real process parameter to be determined for the further influence of the real process fluid flow. Aspects of the disclosure thereby have on the one hand the advantage that a cost-effective system for the determination of a real process parameter is provided because cost-effective real sensors and their integration in the real flow route of the process plant as well as their connection to a process regulation system can be dispensed. This is because the determination of a real process parameter does not have to take place on the real level via real sensors but can take place according to the disclosure on the virtual level. Furthermore, it was found to be advantageous, contrary to the previously known process plant control systems as well as process plant simulation systems, on which the simulation was only employed for simulation, control or prediction purposes, to employ the virtual level, in which the virtual twin flow route influences a twin process fluid flow via twin field devices corresponding to the real operation virtually, besides the process plant simulation also additionally to the process plant control and/or regulation. Furthermore, the system according to the disclosure can also be employed to make a prediction for example with respect to wear, such as cavitation and/or abrasion.

In other words, the system according to the disclosure comprises a virtual level for virtually modeling the real process plant, namely in such a way in that the virtual level provides a virtual twin flow route with at least one twin field device in order to virtually model the real process plant operation. If, for example, an inlet pressure has to be determined at a specific position along the real flow route, the same can take place according to the disclosure by means of the virtual twin flow route provided by the system so that a significant cost reduction is achieved. The twin flow route receives a real initial parameter of the real process fluid flow and/or the real field device as initial value and virtually determines a twin process parameter by means of the twin influence factors of the at least one field device deposited in the twin flow route. The virtual determination of the twin process parameter takes place for example fluid upstream in such a way that the virtually determined twin process parameter is supplied for the further influence of the real process fluid flow to the at least one real field device as the real inlet pressure to be determined.

According to an exemplary embodiment of the system according to the disclosure, the real field device influences the real process fluid flow by means of the real process parameter to be determined and supplied to the real field device. As already described, the system according to the disclosure allows the dispensation of a plurality of real sensors in the process plant and the virtually determined twin process parameters can be employed for the control and/or regulation of the real process fluid flow. In an exemplary further development, the twin field device influences the twin process fluid flow by means of the virtual twin process parameter corresponding to the real process parameter, particularly of the previously virtually determined twin process parameter. Preferably, the virtual influence takes place in real time and/or parallel to the influence of the real process fluid flow in the real process plant.

In an exemplary embodiment of the system according to the disclosure, the field device-specific twin influence factor is modeled by means of a calculation and/or simulation algorithm. Preferably, the calculation and/or simulation algorithm is based on a real field device-specific characteristic.

For example, the calculation and/or simulation algorithm can be based on a real field device-specific characteristic for a field device stroke, such as control valve stroke, preferably control valve stroke, a flow rate, a pressure difference, a temperature progression and/or cycles, medium, pressure and/or flow dependent wear factors. It is possible that the real field device-specific characteristics can be derived from experience values. It is further thinkable that the calculation and/or simulation algorithm is calculated theoretically, during an initialization or calibration of the real field device, or experimentally prior to the initial operation of the real field device, for example during a field device type check. For example, the real field device can be tested and driven, respectively, without the real process fluid flow during the initialization. During a calibration, a deviation of the real field device operation status compared to a predefined target real field device operation state can be determined and documented iteratively. Furthermore, building on that, a possibly determined deviation during a subsequent usage of the real field device can be considered. A type check is understood as a process, with which the real field device is technically checked in order to find out whether the real field device is suited to comply with predefined requirements. Preferably, real field device-specific characteristics, such as described above, are deposited to the virtual twin flow routes and the twin field devices arranged in the twin flow routes, respectively, so that a reliable and realistic virtual influence of the twin process fluid flow can be realized by means of the twin field device in the twin flow route.

According to an exemplary embodiment of the system according to the disclosure, the virtual twin flow route carries out the influence of the twin process fluid flow according to the twin influence factor by the twin field device in real time and/or parallel to the influence of the real process fluid flow according to the real influence factor in the real flow route by the real field device. Thereby, a precise and always adapted to the real process fluid flow in the twin stream route can be virtually modeled.

In a further exemplary embodiment, the virtual modeling of the virtual twin flow route and the virtual influence of the twin process fluid flow according to the twin influence factor by the at least one twin field device takes place on an internet-based IT infrastructure and/or on a local computer associated with the at least one real field device. Typical internet-based IT infrastructures, such as computer clouds or data clouds, in particular cloud solutions, can be employed. For example, a local computer locally associated with the at least one real field device can be a computer coupled to the real field device and/or arranged locally at the real field device in the real flow route. The provision of an internet-based IT infrastructure on the one hand and of a local real field device computer on the other hand can on the one hand have the advantage that a faster adaption of the real process operation is possible, that means without falling back on the internet-based IT infrastructure. On the other hand, a certain security aspect is provided for the exemplary case that the IT infrastructure becomes inoperative temporarily. In this case, the determination of the real process parameter of the respective real field device and its regulation and/or control by means of the real process parameters can be executed on the local operation. As soon as the internet-based IT infrastructure is available, the same can gain access to the local computer in order to adapt the virtually modeled twin flow route in the IT infrastructure to the real process planned operation.

In an exemplary embodiment of the system according to the disclosure, the computing power needed for virtually modeling the twin flow route and for virtually influencing the twin process fluid flow according to the twin influence factor by the twin field device is distributed to the internet-based IT infrastructure and the local computer assigned to the at least one real field device. This can be particularly of advantage for the case in which the requirements to a real-time modeling and regulation, respectively, and/or control are increased. For example, a distribution of the computing power for technical applications according to ATEX explosion safety can be advantageous, on which a too strong heating of the real field device has to be avoided. For such application fields, maximal power values of about 15 W, particularly maximal 12 W, 10 W, or 8 W, are resulting. In this case, the computing powers executable by the local computer are then limited. Preferably, the needed computing power can be distributed to the internet-based IT infrastructure and the local computer assigned to the at least one real field device in such a way that the computing intensive calculations take place in the internet-based IT infrastructure and preferably less computing intensive calculations are executed on the real field device-specific computer so that in particular the requirements to the real-time modeling and regulation, respectively, and/or control are complied with. The Dhrystone computing power can be used, which is for example specified in DMIPS. This is basically composed of integer arithmetic, of string operators, logic decisions and storage access, whereby most of the applications are covered. It specifies the mean time that an IT infrastructure and a computer, respectively, needs for a certain number of iterations of a single loop. For example, computing powers greater than 50,000 DMIPS, preferably greater than 45,000 DMIPS, 40,000 DMIPS or 35,000 DMIPS, can take place in the internet-based IT infrastructure. It is furthermore thinkable to use the internet-based IT infrastructure and the local computers as redundant IT systems, for example in order to realize a control possibility and/or a failsafe safety of at least one of the systems. For the local computer, the known Nvidia Jetson TX2 embedded AI module can be used. The It infrastructure can for example be a cloud application, which is realized by a standard server, which can be characterized by 16 kernels/16 GB RAM storage. Preferably, the cloud application can be scalable so that several equally powerful or different servers can be combined with each other in order to achieve an increase of power and/or a distribution of load. Furthermore, an increase of fail safety can thereby be achieved. Thereby, also Docker Swarm technologies can be applied, which can generate clusters and can be administrated like a single virtual system. Clustering can thereby be useful, since cooperative system groups can be generated thereby, which can prevent a system failure, such as a node failure, through redundancy and in addition a possibility is provided to add or remove iterations in case requirements change. In this context, so-called Kubernetes can be employed, which is an open-source system for the automatization of the provision, scaling and administration of such Docker Swarm technologies.

Furthermore, it can be provided according to the present disclosure that for the avoidance of a delay or latency time, time and/or safety critical calculations are executed on the local computer. This has on the one hand the background that for example cloud solutions can file and thereby the safety, in particular fail safety, of the system is increased. On the one hand, the system can be formed in such a way according to the disclosure that at least two local computers of at least two real field devices are connected to each other communicatively, particularly via a local network connection, with which a smaller ping, which can particularly also comprise the packet run time RTT, can be achieved compared to a communication via the cloud solution.

In an exemplary further development of the system according to the disclosure, the Internet-based IT infrastructure and/or the local computer carries out a comparison of the real initial parameter of the at least one real field device with the virtually determined twin initial parameter assigned to the real initial parameter. For example, this comparison is based on the assumption that during normal operation, that means during an operation, which is not governed by wear or other influence factors, the real initial parameter present in the real flow route more or less equals the virtually determined twin initial parameter assigned to the real initial parameter, determined at the twin tap position in the twin flow route corresponding to the real tap position of the real initial parameter. In case the system according to the disclosure does not detect a deviation or no deviation, it can be decided by means of a comparison of real process parameter and twin process parameter, if the real process parameter to be determined is updated by the twin process parameter virtually determined by means of the real initial parameter and the twin influence factor. Thereby it can always be guaranteed that the virtual twin flow route is modeled best possible, that means best possibly close to reality the real flow route.

According to an exemplary further development of the system, the virtually determined twin process parameter is supplied to the at least one real field device as the real process parameter to be determined for the further influence of the real process fluid flow when, in particular exclusively when, a deviation of the real initial parameter received from the twin flow route from the virtually formed twin initial parameter exceeds a predefined, such as stored in a database input via a user interface or field specific limit value. Preferably, the virtually determined twin process parameter is supplied to the at least one real field device when the above-described deviation exceeds at least 2%, 3%, 4%, 5%, 6%, 7%, 8%, 9% or at least 10%. Alternatively or additionally, the virtually determined twin process parameter is supplied to the at least one real field device as the to be determined real process parameter for the further influence of the real process fluid flow at least when the real initial parameter deviates for a predetermined period of time and/or a predetermined number of comparison operations from the twin initial parameter. A comparison operation can for example be understood as a single comparison computation step between real initial parameter and twin initial parameter, which is for example executed continuously, particularly during introduction of a predefined field device state, or on request for example by means of a user interface. Thereby, on the one hand, a certain amount of sensitivity and reaction responsiveness of the system towards deviations between real flow route and twin flow route can be achieved and on the other hand a type of oversensitivity can be avoided, namely towards that the system itself executes interventions into the real process operation also by the slightest or short-time deviations of the real process parameter from the twin process parameter.

In an exemplary embodiment of the system according to the disclosure, at least one real sensor device is integrated in the real flow route for the field device. For the sensor device, known sensors, such as for example a temperature sensor, velocity sensor, pressure sensor, volume flow capture sensor or such, can be employed. The sensor device is also designed to capture the real initial parameter of the real process fluid flow, such as temperature, velocity, pressure, volume flow or such and/or of the real field device, such as travel, pump power or such. Depending on the sensor device and captured real initial parameter, respectively, a respective twin initial parameter is virtually formed in the virtual twin flow route. That means, that the twin influence factor is selected depending on the sensor device and the captured real initial parameter, respectively, and preferably the calculation and/or simulation algorithm is selected correspondingly. In particular, the sensor device can be connected to the system communicating wirelessly, preferably internet-based. Furthermore, the sensor device can be connected communicating with the internet-based IT infrastructure and/or the local computer wirelessly, preferably internet-based.

According to a further aspect of the present disclosure, which is combinable with the previous aspects, a method for the determination of a real process parameter of at least one real field device, such as a control valve or a pump, which is integrated in a real flow route of a process plant, such as a chemical plant, a food processing plant, a power plant or such, and is designed for influencing, such as setting, driving, warming, cooling or such, of the real process fluid flow according to a field device-specific real influence factor, is provided. According to the disclosure, the real process route of the method is modeled virtually and a twin process fluid flow is influenced virtually according to a twin influence factor of at least one twin field device corresponding to the at least one real field device, the twin influence factor corresponding to the real influence factor of the at least one real field device. Furthermore, a real initial parameter of the real process fluid flow, such as temperature, velocity, pressure, volume flow or such, and/or a real initial parameter of the real field device, such as travel, pump power, or such, is received. A twin process parameter of the twin field device corresponding to the at least one real field device is determined fluid flow upstream or downstream by means of the at least one twin influence factor. The virtually determined twin process parameter can be supplied to the at least one real field device as the to be determined real process parameter for the further influence of the real process fluid flow. Thereby, a cost-effective method for the determination of a real process parameter is provided, in which a plurality of cost-intensive real sensors and their integration in the real flow route of the process plant as well as their connection to the process regulation system can be dispensed. The determination of the real process parameter of the real operation as well as the real process plant control and/or regulation can take place by means of the virtual twin level.

According to a further development of the method according to the disclosure, the method can be characterized according to the above-described system for the determination of a real process parameter of at least one real field device according to the disclosure.

According to a further development of the present disclosure, which is combinable with the previous aspects, the present disclosure provides a real field device, such as a control valve and/or pump, which is integrated in the real flow route of a process plant, such as a chemical plant, a food processing plant, a power plant or such. The real field device can be integrated in the real flow route in such a way that it is designed for influencing, such as setting, driving, warming, cooling or such, the real process fluid flow according to a real field device-specific real influence factor. The real field device can have an internet-based IT infrastructure, such as a computer cloud or data cloud, associated with the real field device and/or a local computer for virtually modeling the real field device and for virtually influencing a twin field device corresponding to a real field device according to the real influence factor of the twin influence factor corresponding to the at least one real field device. The internet-based IT infrastructure and/or the local computer can receive a real initial parameter of the real process fluid flow, such as temperature, velocity, pressure, volume flow or such, and/or a real initial parameter of the real field device, such as travel, pump power or such. Furthermore, the real field device is designed to virtually determine process fluid flow upstream or downstream a twin process parameter of the twin field device corresponding to the real field device by means of the at least one twin influence factor. The virtually determined twin process parameter can be supplied to the real field device for the further influence of the real process fluid flow. In particular, the twin process parameter is supplied to the real field device in such a way that the real field device is adapting its previous field device-specific real influence factor to the twin process parameter. The real field device according to the disclosure can thereby determine a real parameter cost-efficiently without the need to fall back on cost-intensive real sensors, which need to be integrated into the real flow route of the process plant in a laborious way. The determination of the real process parameter of the real operation as well as the real field device control and/or regulation can take place by means of the virtual twin level.

In an exemplary embodiment of the real field device according to the disclosure, the real field device comprises a system for the determination of a real process parameter of the real field device according to the disclosure, whereby the system according to the disclosure can be formed as described above. In this exemplary embodiment of the real field device according to the disclosure, the system according to the disclosure can be integrated in the IT infrastructure and/or the local computer. Furthermore, the real field device can be formed in such a way that it is suitable for the execution of the method for the determination of a real process parameter of the real field device according to the disclosure, as it was described with reference to the exemplary embodiment of the method according to the disclosure.

According to a further aspect of the present disclosure, which is combinable with the previous aspects, a real flow route of a process plant, such as a chemical plant, a food processing plant, a power plant or such, is provided for guiding the real process fluid flow. The real flow route comprises at least one field device, such as a control valve and/or pump, integrated in the real flow route for influencing, such as setting, driving, warming, cooling or such, the real process fluid flow according to a real field device-specific real influence factor. The real flow route further comprises an internet-based IT infrastructure, such as a computer cloud or data cloud, associated with the real flow route and/or a local computer for the virtual modeling of the real field device and for virtually influencing a twin field device corresponding to a real field device according to a twin influence factor corresponding to a real influence factor of the at least one real field device. The internet-based IT infrastructure and/or the local computer receives and receive, respectively, a real initial parameter of the real process fluid flow, such as temperature, velocity, pressure, volume flow or such, and/or a real initial parameter of the at least one real field device, such as a travel, a pump power or such, and virtually determine and determines, respectively, process fluid flow upstream or downstream a twin process parameter of the twin field device corresponding to the real field device by means of the at least one twin influence factor. The virtually determined twin process parameter is supplied to the at least one real field device for further influencing the real process fluid flow, preferably supplied as the to be determined real process parameter. Thereby, a real parameter can be determined by the real flow route according to the disclosure in a cost-effective way, without the need to fall back on cost intensive real sensors, which have to be integrated in the real flow route of the process plant in a laborious way. The determination of the real process parameter of the real operation as well as the real field device control and/or regulation in the real flow route can take place by means of the virtual twin level.

In an exemplary embodiment of the real flow route according to the disclosure, the real flow route comprises a system for the determination of a real process parameter and the at least one real field device in the real flow route, particularly as described above, integrated in the IT infrastructure and/or the local computer. Alternatively, or additionally, the real flow route comprises a real field device for influencing, such as setting, driving, warming, cooling or such, the real process fluid flow, in particular as described above, integrated in the real flow route. Furthermore, the real flow route can be formed for the execution of the above-described method according to the disclosure for the determination of a real process parameter of the at least one real field device.

The system for the determination of a real process parameter of at least one real field device integrated in a real flow route of a process plant is denoted generally with the reference numeral 1 in the following exemplary description of an embodiment. The exemplary principle sketch is essentially to be understood that a real level 11 (bottom of the Figure) is separated from a twin level 111 by an imaginary separation line and separation level 3, indicated by means of dotted lines, in which the real level 11 is virtually represented.

The real level 11 relates to the real process operation of the real process plant (not depicted), from which a section of a real flow route 13 for guiding the real process fluid flow is shown. In the real flow route 13, four real field devices 15 for influencing, such as setting, driving, warming, cooling or such, of the real process fluid flow according to a respective real field specific real influence factor are integrated. The process fluid flow direction P is indicated by means of an arrow and progresses in the exemplary embodiment from the left to the right through the exemplary section of the real flow route 13. Observed in process fluid flow direction P, the section of the real flow route 13 comprises a control valve 15.1, a pump 15.2 arranged process fluid upstream, a heater 15.3 arranged furthermore process fluid flow upstream and a valve 15.1 arranged furthermore process fluid flow upstream. Each of the real field devices 15 has a real field device-specific real influence factor, according to which the respective real field device 15 influences the real process fluid flow. In so far, the real influence factor of the respective real field device 15 determines the real process fluid flow state at the respective position along the real flow route 13.

In the twin level 111, a section of the virtual twin flow route 113 is shown, which corresponds to the section of the real flow route 13. That means that the real flow route 13 is virtually represented in the twin flow route 113 and influences a twin process fluid flow virtually according to the twin influence factors virtually corresponding to the real field devices 15 according to the real influence factors. The twin process fluid flow direction is indicated by means of the arrow with the reference numeral P′ and corresponds to the flow direction of the real process fluid flow P.

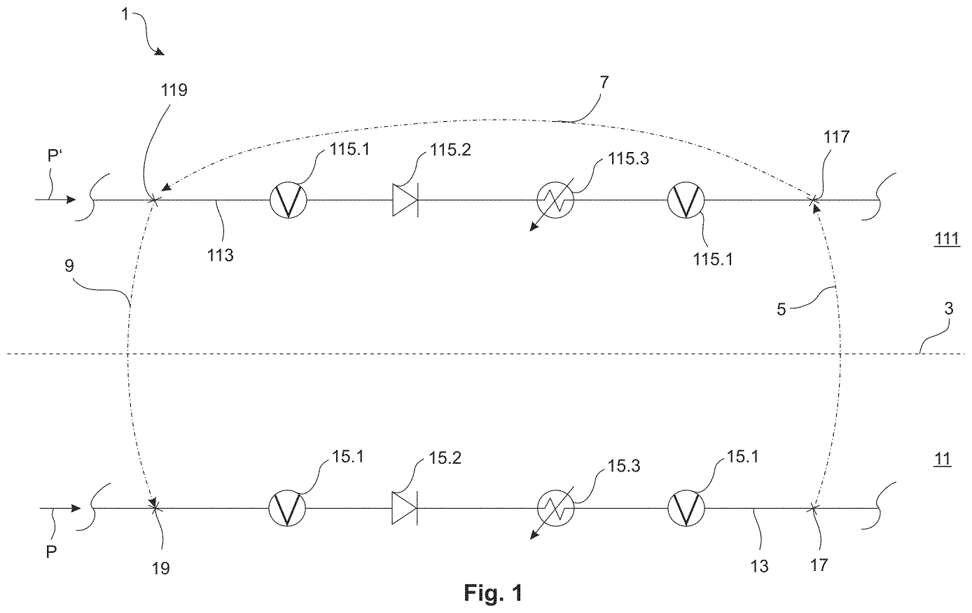

The system 1 according to the disclosure is thereby formed in such a way that the virtual twin flow route 113 receives a real initial parameter 17, which for example can be associated with the real process fluid flow and for example be a temperature, velocity, pressure, volume flow or such and/or can be associated with the real field device 15 and for example be a travel, a pump power or such. In the exemplary embodiment according to FIG. 1, the real initial parameter 17 is an upstream real initial parameter of the shown section of the real flow route 13. The twin flow route 113 thereby receives the real initial parameter 17, which has the reference numeral 117 in the twin level 111, at a position, that means seen in the stream direction P′, which corresponds to the position in the real flow route 13 observed in the flow direction P, and particularly on which the real initial parameter 17 was tapped. The receiving of the real initial parameter 17 by the twin flow route 113 is indicated by means of a dashed arrow with the reference numeral 5.

Depending on the real process parameter to be determined along the real flow route 13, i.e. depending on the position of the real process parameter to be determined with respect to the field devices 15 integrated in the real flow route 13, the virtual twin flow route 113 virtually determines a twin process parameter of the twin field device 115 corresponding to the respective real field device 15. That means that, if, as shown in FIG. 1, the to be determined real process parameter 19 is to be determined at an upstream position along the section of the real process route 13, whose position thereby is located upstream of the first real control valve 15.1, the virtual twin flow route 113 is determined by means of the twin influence factors of the twin field devices 115.1, 115.2, 115.3, and 115.1 corresponding to the real field devices 15.1, 15.2, 15.3 and 15.1 according to a respective twin process parameter 119 virtually, as shown in FIG. 1 schematically. The step of a virtual determination of the virtual twin flow route 113 is indicated by a dashed line 7 in the twin level 111. It shall be clear that for example if the to be determined real process parameter should be determined at a different position along the real flow route 13, for example between the first real control valve 15.1 and the real pump 15.2, the virtual determination 7 takes place in such a way that the virtual twin process parameter is determined at the respective position along the twin flow route 113 between the twin control valve 115.1 and the twin pump 115.2.

The virtually determined twin process parameter 119 can be supplied by means of the system 1 according to the disclosure for the determination of a real process parameter 19 of the real field device 15.1 in the real flow route 13 as the to be determined real process parameter 19 for the further influence of the real process fluid flow P to the respective real field device 15, particularly the real control valve 15.1, as shown in FIG. 1. The step of the supply of the twin process parameter 119 to the real field device 15.1 is indicated by means of the dashed line 9. Thereby, a real sensor device, for example a real temperature sensor, velocity sensor, pressure sensor, volume flow sensor or such, can be dispensed at the respective position in the real flow route 13, that means upstream of the real control valve 15.1, and thereby the costs of the process plant can be reduced.

Further exemplary and advantageous embodiments of the system 1 according to the disclosure are provided in the previous description of exemplary embodiments.

The features disclosed in the previous description, the Figures and the claims can be of importance for the realization of the disclosure in the various embodiments singularly as well as in arbitrary combination.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1system

3 separation level

5, 7, 9 arrow

11 real level

13 real flow route

15.1, 15.2, 15.3 real field device

17 real initial parameter

19 real process parameter

111 twin level

113 twin flow route

115.1, 115.2, 115.3 twin field device

117 twin initial parameter

119 twin process parameter

P real process fluid flow direction

P′ twin process fluid flow direction

1. A system for the determination of a real process parameter of at least one real field device that is integrated in a real flow route of a process plant and configured to influence a real process fluid flow according to a field device-specific real influence factor, comprising:
an interface; and
a virtual twin flow route that is configured to virtually represent the real flow route, a twin process fluid flow being virtually influenced according to a twin influence factor, of at least one twin field device corresponding to the at least one real field device, corresponding to the real influence factor of the at least one real field device,
wherein the virtual twin flow route is configured to:
receive, via the interface, a real initial parameter of the real process fluid flow and/or of the real field device, and
virtually determine, fluid flow upstream or downstream, a twin process parameter of the twin field device corresponding to the at least one real field device using the at least one twin influence factor, the virtually determined twin process parameter being supplied to the at least one real field device as the to be determined real process parameter for further influencing the real process fluid flow.

2. The system according to claim 1, wherein the at least one real field device influences the real process fluid flow by the to be determined real process parameter supplied to the at least one real field device, the twin field device influencing the twin process fluid flow virtually parallel in real time by the virtual twin process parameter corresponding to the real process parameter.

3. The system according to claim 1, wherein the field device-specific twin influence factor is formed by a calculation and/or simulation algorithm, which is based on a real field device-specific characteristic for a field device stroke wherein the calculation and/or simulation algorithm is calculated theoretically, for an initialization or calibration of the real field device prior to initial operation of the real field device determined experimentally for a field device type check.

4. The system according to claim 1, wherein the virtual twin flow route is configured to execute the influence of the twin process fluid flow according to the twin influence factor by the twin field device in real time and/or parallel to the influence of the real process fluid flow according to the real influence factor in the real fluid route by the real field device.

5. The system according to claim 1, wherein the virtual representation of the virtual twin flow route and the virtual influence of the twin process fluid flow according to the twin influence factor by the at least one twin field device takes place in an internet-based infrastructure and/or on a local computer associated to the at least one real field device.

6. The system according to claim 5, wherein a computation power needed for the virtual representation of the twin flow route and for the virtual influence of the twin process fluid flow according to the twin influence factor by the twin field device is distributed to the internet-based infrastructure and the local computer associated with the at least one real field device.

7. The system according to claim 5, wherein the internet-based infrastructure and/or the local computer is configured to execute a comparison of the real initial parameter of the at least one real field device received by the real flow route with the virtually determined twin initial parameter associated with the real initial parameter, wherein it is determined, based on the comparison of the real process parameter and the twin process parameter, if the to be determined real process parameter is to be updated by the twin process parameter determined virtually by the real initial parameter.

8. The system according to claim 7, wherein the virtually to be determined twin process parameter is supplied to the at least one real field device as the to be determined real process parameter for further influencing the real process fluid flow in response to:
a deviation of the real initial parameter received from the twin flow route from the virtually-formed twin initial parameter exceeding a predetermined limit value, and/or
the real initial parameter deviating from the twin initial parameter for a predetermined period of time.

9. The system according to claim 1, wherein at least one sensor is integrated in the real flow route fluid flow upstream of the at least one real field device and is configured to capture the real initial parameter of the real process fluid flow.

10. A method for the determination of a real process parameter of at least one real field device integrated in a real flow route of a process plant and configured to influence the real process fluid flow according to a field device-specific real influence factor, the method comprising:
virtually representing the real flow route; and
virtually influencing a twin process fluid flow according to a twin influence factor, of at least one twin field device corresponding to the at least one real field device, corresponding to the real influence factor of the at least one real field device;
receiving a real initial parameter of the real process fluid flow and/or of the real field device;
virtually determining a twin process parameter of the twin field device corresponding to the at least one real field device, fluid flow upstream or downstream, based on at least one twin influence factor; and
providing the virtually determined twin process parameter to the at least one real field device as the to be determined real process parameter to further influence the real process fluid flow.

11. (canceled)

12. A real field device integratable in a real flow route of a process plant and configured to influence the real process fluid flow according to a fluid device-specific real influence factor, the real field device comprising:
an internet-based infrastructure associated with the real field device and/or a computer, configured to:
virtually represent the real field device and virtually influence a twin field device associated with the real field device according to a twin influence factor associated with a real influence factor of the real field device,
receive a real initial parameter of the real process fluid flow and/or of the real field device,
virtually determine, fluid flow upstream or downstream, a twin process parameter of the twin field device corresponding to the real field device based on the at least one twin influence factor, and
provide the virtually determined twin process parameter to the real field device to further influence the real process fluid flow.

13. (canceled)

14. A real flow route of a process plant for guiding a real process fluid flow, comprising:
at least one real field device integrated in the real flow route configured to influence the real process fluid flow according to a field device-specific real influence factor,
an internet-based infrastructure associated with the real flow route configured to virtually represent the real field device and virtually influence a twin field device associated to the real field device according to a twin influence factor corresponding to a real influence factor of the at least one real field device, wherein the internet-based infrastructure is configured to:
receive a real initial parameter of the real process fluid flow and/or of the at least one real field device,
virtually determine, fluid flow upstream or downstream, a twin process parameter of the twin field device corresponding to the real field device based on the at least one twin influence factor, and
provide the virtually determined twin process parameter to the real field device to further influence the real process fluid flow.

15. (canceled)

16. The system according to claim 1, wherein the real initial parameter of the real process fluid flow is a temperature, a velocity, a pressure, or a volume.

17. The system according to claim 1, wherein the real field device is a control valve or a pump.
